(19) United States
(12) Patent Application Publication
(10) Pub. No.: US 2013/0113882 A1
(43) Pub. Date: May 9, 2013

(54) VIDEO CODING SYSTEM AND METHOD OF OPERATION THEREOF

(71) Applicant: Sony Corporation, Tokyo (JP)

(72) Inventors: Munsi Haque, San Jose, CA (US); Ali Tabatabai, Cupertino, CA (US)

(73) Assignee: SONY CORPORATION, Tokyo (JP)

(21) Appl. No.: 13/670,176

(22) Filed: Nov. 6, 2012

Related U.S. Application Data
(60) Provisional application No. 61/557,275, filed on Nov. 8, 2011.
(60) Provisional application No. 61/624,714, filed on Apr. 16, 2012.

(51) Int. Cl. H04N 7/26; H04N 13/00

(52) U.S. Cl. 348/43; 375/240.01; 375/240.25; 348/E13.001; 375/E07.027; 375/E07.199

(57) ABSTRACT

A method of operation of a video coding system includes: receiving a video bitstream; identifying a syntax type of the video bitstream; extracting a video syntax from the video bitstream for the syntax type; and forming a video stream based on the video syntax for displaying on a device.

### CROSS-REFERENCE TO RELATED APPLICATION

This application claims the benefit of U.S. Provisional Patent Application Ser. No. 61/557,275 filed Nov. 8, 2011, and U.S. Provisional Patent Application Ser. No. 61/624,714 filed Apr. 16, 2012 and the subject matter thereof is incorporated herein by reference in its entirety.

### TECHNICAL FIELD

The present invention relates generally to video systems, and more particularly to a system for video coding.

### BACKGROUND ART

The deployment of high quality video to smart phones, high definition televisions, automotive information systems, and other video devices with screens has grown tremendously in recent years. The wide variety of information devices supporting video content requires multiple types of video content to be provided to devices with different size, quality, and connectivity capabilities.

Video has evolved from two dimensional single view video to multiview video with high-resolution three dimensional imagery. In order to make the transfer of video more efficient, different video coding and compression schemes have tried to get the best picture from the least amount of data. The Moving Pictures Experts Group (MPEG) developed standards to allow good video quality based on a standardized data sequence and algorithm. The H.264 (MPEG4 Part 10)/Advanced Video Coding design was an improvement in coding efficiency typically by a factor of two over the prior MPEG-2 format. The quality of the video is dependent upon the manipulation and compression of the data in the video. The video can be modified to accommodate the varying bandwidths used to send the video to the display devices with different resolutions and feature sets. However, distributing larger, higher quality video, or more complex video functionality requires additional bandwidth and improved video compression.

Thus, a need still remains for a video coding system that can deliver good picture quality and features across a wide range of device with different sizes, resolutions, and connectivity. In view of the increasing demand for providing video on the growing spectrum of intelligent devices, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to save costs, improve efficiencies and performance, and meet competitive pressures, adds an even greater urgency to the critical necessity for finding answers to these problems.

Solutions to these problems have long been sought but prior developments have not taught or suggested any solutions and, thus, solutions to these problems have long eluded those skilled in the art.

### DISCLOSURE OF THE INVENTION

The present invention provides a method of operation of a video coding system including: receiving a video bitstream; identifying a syntax type of the video bitstream; extracting a video syntax from the video bitstream for the syntax type; and forming a video stream based on the video syntax for displaying on a device.

The present invention provides a video coding system, including: a receive module for receiving a video bitstream; a get type module, coupled to the receive module, for identifying a syntax type from the video bitstream; a get syntax module, coupled to the get type module, for extracting a video syntax from the video bitstream for the syntax type; and a decode module, coupled to the get syntax module, for forming a video stream based on the video syntax and the video bitstream for displaying on a device.

Certain embodiments of the invention have other aspects in addition to or in place of those mentioned above. The aspects will become apparent to those skilled in the art from a reading of the following detailed description when taken with reference to the accompanying drawings.

### BRIEF DESCRIPTION OF THE DRAWINGS

FIG. 1 is a block diagram of a video coding system in an embodiment of the present invention.

FIG. 2 is an example of an Advanced Video Coding (AVC) Video Usability Information (VUI) syntax.

FIG. 3 is an example of a Scalable Video Coding (SVC) VUI syntax.

FIG. 4 is an example of a SVC VUI syntax extension.

FIG. 5 is an example of a Multiview Video Coding (MVC) VUI syntax.

FIG. 6 is an example of a MVC VUI syntax extension.

FIG. 7 is an example of a Multiview Video plus Depth (MVD) VUI syntax.

FIG. 8 is an example of a MVD VUI syntax extension.

FIG. 9 is an example of a Stereoscopic Video (SSV) VUI syntax extension.

FIG. 10 is a functional block diagram of the video coding system.

FIG. 11 is a control flow of the video coding system.

FIG. 12 is a flow chart of a method of operation of the video coding system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that process or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

Likewise, the drawings showing embodiments of the system are semi-diagrammatic and not to scale and, particularly, some of the dimensions are for the clarity of presentation and are shown greatly exaggerated in the drawing FIGs. Where multiple embodiments are disclosed and described, having some features in common, for clarity and ease of illustration, description, and comprehension thereof, similar and like features one to another will ordinarily be described with like reference numerals.

The term “syntax” means the set of elements describing a data structure. The term “module” referred to herein can include software, hardware, or a combination thereof in the present invention in accordance with the context used.

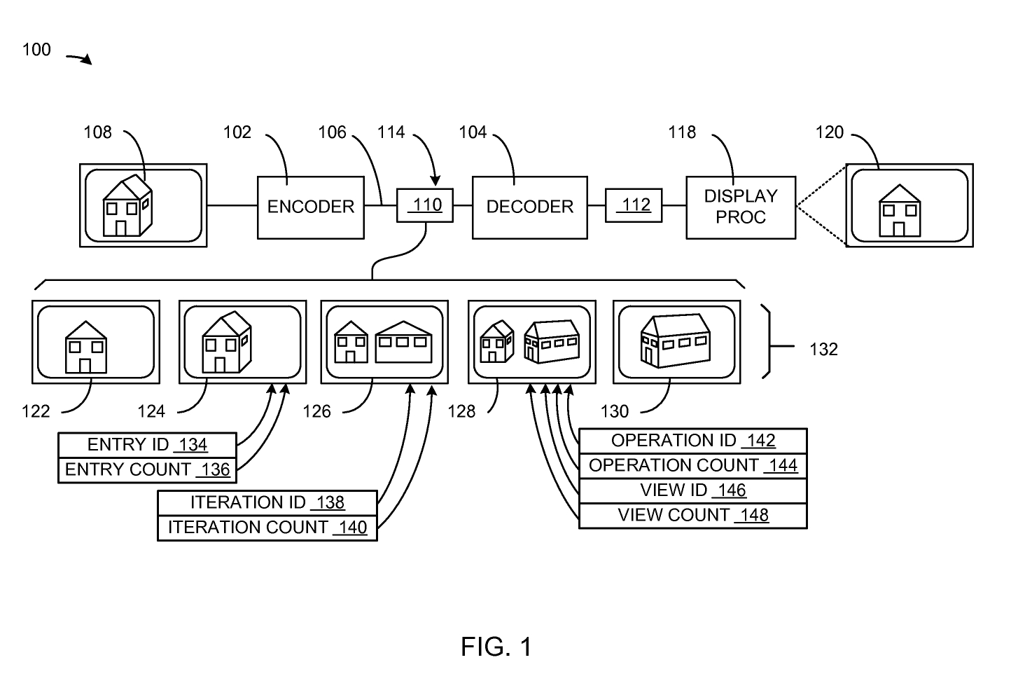

Referring now to FIG. 1, therein is shown a block diagram of a video coding system 100 in an embodiment of the present invention. A video encoder 102 can receive a video content 108 and send a video bitstream 110 to a video decoder 104 for decoding and display on a display interface 120.

The video encoder 102 can receive and encode the video content 108. The video encoder 102 is a unit for encoding the video content 108 into a different form. The video content 108 is defined as a visual representation of a scene of objects.

Encoding is defined as computationally modifying the video content 108 to a different form. For example, encoding can compress the video content 108 into the video bitstream 110 to reduce the amount of data needed to transmit the video bitstream 110.

In another example, the video content 108 can be encoded by being compressed, visually enhanced, separated into one or more views, changed in resolution, changed in aspect ratio, or a combination thereof. In another illustrative example, the video content 108 can be encoded according to High-Efficiency Video Coding (HEVC)/H.265

The video encoder 102 can encode the video content 108 to form the video bitstream 110. The video bitstream 110 is defined a sequence of bits representing information associated with the video content 108. For example, the video bitstream 110 can be a bit sequence representing a compression instance of the video content 108.

The video encoder 102 can receive the video content 108 for a scene in a variety of ways. For example, the video content 108 representing objects in the real-world can be captured with a video camera, multiple cameras, generated with a computer, provided as a file, or a combination thereof.

The video content 108 can support a variety of video features. For example, the video content 108 can include single view video, multiview video, stereoscopic video, or a combination thereof. In a further example, the video content 108 can be multiview video of four or more cameras for supporting three-dimensional (3D) video viewing without 3D glasses.

The video encoder 102 can encode the video content 108 using a video syntax 114 to generate the video bitstream 110. The video syntax 114 is defined as a set of information elements that describe a coding methodology for encoding and decoding the video content 108. The video bitstream 110 is compliant with the video syntax 114, such as the High-Efficiency Video Coding/H.265 standard, and can include a HEVC video bitstream, an Ultra High Definition video bitstream, or a combination thereof.

The video bitstream 110 can include information representing the imagery of the video content 108 and the associated control information related to the encoding of the video content 108. For example, the video bitstream 110 can include an instance of the video syntax 114 and an instance of the video content 108.

The video coding system 100 can include the video decoder 104 for decoding the video bitstream 110. The video decoder 104 is defined as a unit for receiving the video bitstream 110 and modifying the video bitstream 110 to form a video stream 112.

The video decoder 104 can decode the video bitstream 110 to form the video stream 112 using the video syntax 114. Decoding is defined as computationally modifying the video bitstream 110 to a form the video stream 112. For example, decoding can decompress the video bitstream 110 to form the video stream 112 formatted for displaying on a smart phone display.

The video stream 112 is defined as a computationally modified version of the video content 108. For example, the video stream 112 can include a modified instance of the video content 108 with different properties. The video stream 112 can include cropped decoded pictures from the video content 108.

In a further example, the video stream 112 can have a different resolution, a different aspect ratio, a different frame rate, different stereoscopic views, different view order, or a combination thereof than the video content 108. The video stream 112 can have different visual properties including different color parameters, color planes, contrast, hue, or a combination thereof.

The video coding system 100 can include a display processor 118. The display processor 118 can receive the video stream 112 from the video decoder 104 for display on the display interface 120. The display interface 120 is a unit that can present a visual representation of the video stream 112. For example, the display interface 120 can include a smart phone display, a digital projector, a DVD player display, or a combination thereof.

The video encoder 102 can send the video bitstream 110 to the video decoder 104 over a communication path 106. The communication path 106 can be a variety of networks.

For example, the communication path 106 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 106. Ethernet, digital subscriber line (DSL), fiber to the home (FTTH), and plain old telephone service (POTS) are examples of wired communication that can be included in the communication path 106.

The video coding system 100 can employ a variety of video coding standards. For example, the video coding system 100 can encode and decode video information using the High Efficiency Video Coding/H.265 working draft version. The HEVC draft version is described in documents that are hereby included by reference. The documents incorporated by reference include:

B. Boss, W. Han, J Ohm, G. Sullivan, T. Wiegand, “WD4 Working Draft 4 of High-Efficiency Video Coding”, JCTVC-F803 d1, July 2011 (Torino).

M. Hague, A. Tabatabai, T. Suzuki, “On VUI syntax parameters”, JCTVC-F289, July 2011 (Torino).

M. Hague, K. Sato, A. Tabatabai, T. Suzuki, “HEVC VUI Parameters with Extension Hooks”, JCTVC-J0270, July 2012 (Stockholm).

M. Hague, K. Sato, A. Tabatabai, T. Suzuki, “Simplifications of HRD parameters for Temporal Scalability”, JCTVC-J0272, July 2012 (Stockholm).

M. Hague, K. Sato, A. Tabatabai, T. Suzuki, “A simple ordering issue for VUI parameters syntax”, JCTVC-J0273, July 2012 (Stockholm).

B. Boss, W. Han, J Ohm, G. Sullivan, T. Wiegand, “High-Efficiency Video Coding (HEVC) text specification draft 8”, JCTVC-J1003 d7, July 2012 (Stockholm).

The video bitstream 110 can include a variety of video types as indicated by a syntax type 132. The syntax type 132 is defined as an indicator of the video coding used to encode and decode the video bitstream 110. For example, the video content 108 can include the syntax type 132 for advanced video coding 122, scalable video coding 124, multiview video coding 126, multiview video plus depth video 128, and stereoscopic video 130.

Advanced video coding and scalable video coding can be used to encode single view based video to form the video bitstream 110. The single view-based video can include the video content 108 generate from a single camera.

Multiview video coding, multiview video plus depth, and stereoscopic video can be used to encode the video content 108 having two more views. For example, multiview video can include the video content 108 from multiple cameras.

The video syntax 114 can include an entry identifier 134. The entry identifier 134 is a value for differentiating between multiple coded video sequences. The coded video sequences can include instances of the video content 108 having a different bit-rate, frame-rate, resolution, or scalable layers for a single view video, multiview video, or stereoscopic video.

The video syntax 114 can include an entry count 136 for identifying the number of entries associated with each frame in the video content 108. The entry count 136 is the maximum number of entries represented in the video content 108.

The video syntax 114 can include an iteration identifier 138. The iteration identifier 138 is a value to differentiate between individual iterations of the video content 108.

The video syntax 114 can include an iteration count 140. The iteration count 140 is a value indicating the maximum number of iterations of the video content 108.

For scalable video coding, the term iteration count can be used to indicate the number of information entries tied to different scalable video layers in the case of scalable video coding. For multiview video coding, the iteration count can be used to indicate the number of operation points tied to the number of views of the video content 108.

For example, in scalable video coding, the video content 108 can be encoded to include a base layer with additional enhancement layers to form multi-layer instances of the video bitstream 110. The base layer can have the lowest resolution, frame-rate, or quality.

The enhancement layers can include gradual refinements with additional left-over information used to increase the quality of the video. The scalable video layer extension can include a new baseline standard of HEVC that can be extended to cover scalable video coding.

The video syntax 114 can include an operation identifier 142. The operation identifier 142 is a value to differentiate between individual operation points of the video content 108. The operation points are information entries present for multiview video coding, such as timing information, network abstraction layer (NAL) hypothetical referenced decoder (HRD) parameters, video coding layer (VCL) HRD parameters, a pic_struct_present_flag element, or a combination thereof.

The video syntax 114 can include an operation count 144. The operation count 144 is a value indicating the maximum number of operations of the video content 108.

The operation points are tied to generation of coded video sequences from various views, such as views generated by different cameras, for multiview and 3D video. For multiview video coding, an operation point is associated with a subset of the video bitstream 110 having a target output view and the other views dependent on the target output view. The other views are dependent on the target output view if they are derived using a sub-bitstream extraction process. More than one operation point may be associated with the same subset of the video bitstream 110. For example, decoding an operation point refers to the decoding of the subset of the video bitstream corresponding to the operation point and subsequent output of the target output views as a portion of the video stream 112 for display on the device 102.

The video syntax 114 can include a view identifier 146. The view identifier 146 is a value to differentiate between individual views of the video content 108.

The video syntax 114 can include a view count 148. The view count 148 is a value indicating the maximum number of views of the video content 108.

For example, a single view can be a video generated by a single camera. Multiview video can be generated by multiple cameras situated at different positions and distances from the objects being viewed in a scene.

The video content 108 can include a variety of video properties. For example, the video content 108 can be high resolution video, such as Ultra High Definition video. The video content 108 can have a resolution of 3840×2160 or higher, including resolutions of 7680×4320, 8K×2K, 4K×2K, or a combination thereof. Although the video content 108 supports high resolution video, it is understood that the video content 108 can also support lower resolutions, such as high definition (HD) video. The video syntax 114 can support the resolution of the video content 108.

The video content 108 can support a variety of frame rates including 24 frames per second (fps), 25 fps, 50 fps, 60 fps, and 120 fps. Although individual frame rates are described, it is understood that the video content 108 can support fixed and variable rational frame rates of zero frames per second and higher. The video syntax 114 can support the frame rate of the video content 108.

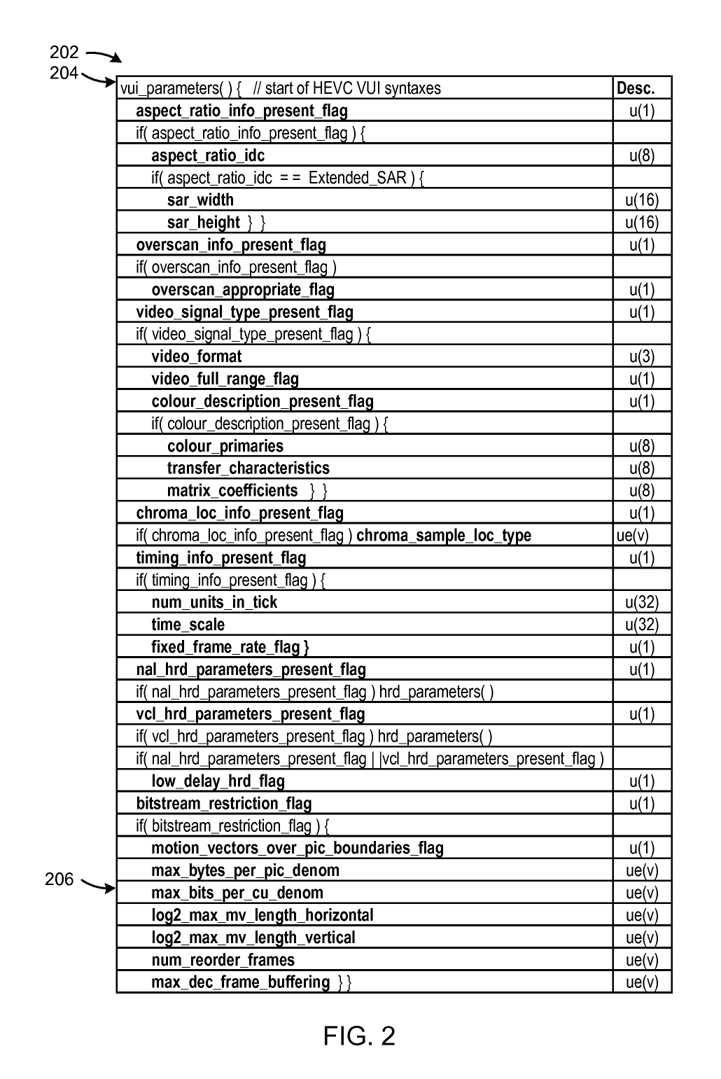

Referring now to FIG. 2, therein is shown an example of an Advanced Video Coding (AVC) Video Usability Information (VUI) syntax 202. The AVC VUI syntax 202 describes configuration elements of the video syntax 114 of FIG. 1 for HEVC.

The AVC VUI syntax 202 includes elements as described in the AVC VUI syntax table of FIG. 2. The elements of the AVC VUI syntax 202 are arranged in a hierarchical structure as described in the AVC VUI syntax table of FIG. 2.

The AVC VUI syntax 202 includes a variety of elements to support the processing of Video Usability Information for HEVC. Processing is defined as modifying video information based on the video syntax 114. For example, processing can include encoding or decoding the video content 108 of FIG. 1 and the video bitstream 110 of FIG. 1 respectively.

The AVC VUI syntax 202 includes an AVC VUI syntax header 204, such as a vui_parameters element. The AVC VUI syntax header 204 is a descriptor for identifying the AVC VUI syntax 202. The AVC VUI syntax 202 is used to encode and decode the video bitstream 110 for AVC.

The AVC VUI syntax can include a coding unit 206, such as a max_bits_per_cu_denom element, to indicate the maximum number of bits per coding unit. The coding unit 206 is a rectangular area of one image of the video content 108 used for compression of the video bitstream 110. The max_bits_per_cu_denom message can replaced the max_bits_per_mb_denom messages in the AVC VUI.

It has been discovered that encoding and decoding the video content 108 using the AVC VUI syntax 202 can reduce the size of the video bitstream 110 and reduce the need for video buffering. Reducing the size of the video bitstream 110 increases functionality and increases the performance of display of the video stream 120 of FIG. 1.

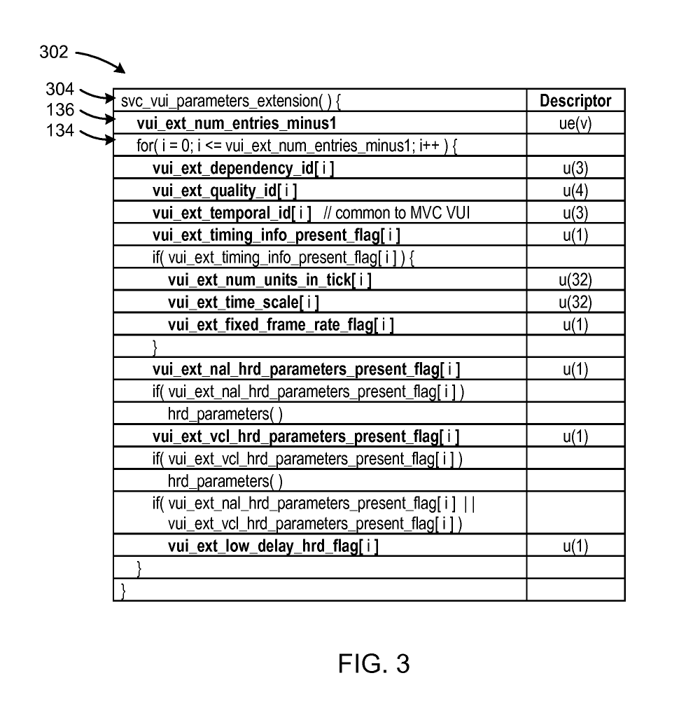

Referring now to FIG. 3, therein is shown an example of a Scalable Video Coding (SVC) VUI syntax 302. The SVC VUI syntax 302 enables an instance of the video bitstream 110 of FIG. 1 to be used at different frame rates, spatial resolutions, or quality levels.

The SVC VUI syntax 302 includes elements as described in the SVC VUI syntax table of FIG. 3. The elements of the SVC VUI syntax 302 are arranged in a hierarchical structure as described in the table of FIG. 3.

The SVC VUI syntax 302 includes a SVC VUI syntax header 304, such as a svc_vui_parameters_extensions element. The SVC VUI syntax header 304 is a descriptor for identifying the SVC VUI syntax 302. The SVC VUI syntax 302 is used to encode and decode the video bitstream 110 for SVC.

The SVC VUI syntax 302 can include the coding unit 206 of FIG. 2, such as a max_bits_per_cu_denom element to indicate the maximum number of bits per coding unit. The max_bits_per_cu_denom message can replaced the max_bits_per_mb_denom messages in the ADC VUI.

The SVC VUI syntax 302 can include the entry identifier 134, such as the element [i]. The SVC VUI syntax 302 can include the entry count 136, such as vui_ext_num_entries_minus1 element, for identifying the number of entries associated with each frame in the video content 108 of FIG. 1. The entry count 136 indicates the number of entries minus 1 to map the entry count 136 from 0 to the number of entries minus 1.

It has been discovered that the SVC VUI syntax 302 enables video scalability by including the vui_ext_dependency_id element, the vui_ext_quality_id element, and the vui_temporal_id element for each entry defined by the vui_ext_num_entries_minus1 element. Spatial scalability, temporal scalability, and quality scalability can be implemented based on the value of the elements for each entry.

It has been discovered that encoding and decoding the video content 108 using the SVC VUI syntax 302 can reduce the size of the video bitstream 110 and reduce the need for video buffering. Reducing the size of the video bitstream 110 increases functionality and increases the performance of display of the video stream 112 of FIG. 1.

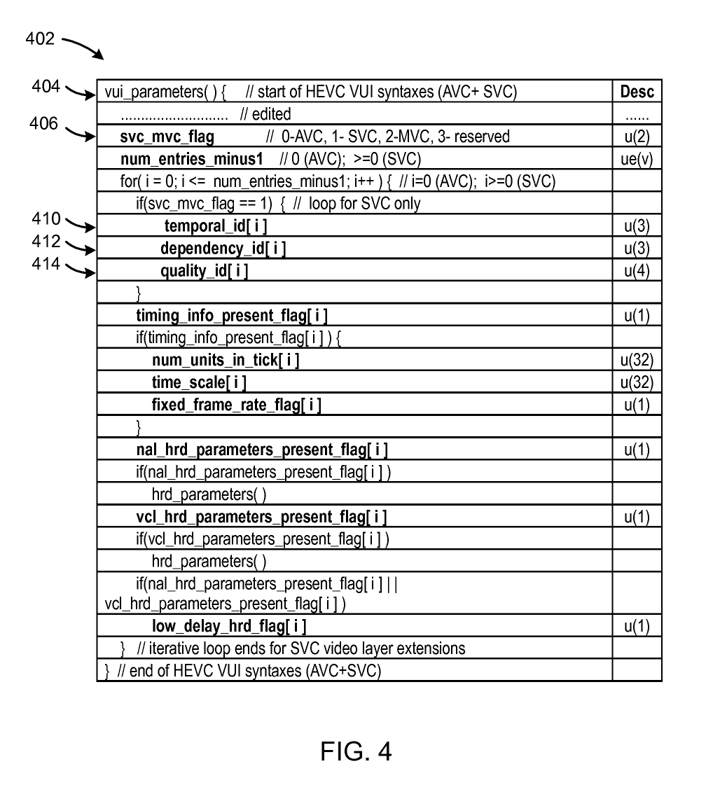

Referring now to FIG. 4, therein is shown an example of a SVC VUI syntax extension 402. The SVC VUI syntax extension 402 includes descriptive video information for Advanced Video Coding and Scalable Video Coding for HEVC.

The SVC VUI syntax extension 402 includes elements as described in the SVC VUI syntax extension table of FIG. 4. The elements of the SVC VUI syntax extension 402 are arranged in a hierarchical structure as described in the SVC VUI syntax extension table of FIG. 4.

The SVC VUI syntax extension 402 includes a SVC VUI syntax extension header 404, such as a vui_parameters element. The SVC VUI syntax extension header 404 is a descriptor for identifying the SVC VUI syntax extension 402. The SVC VUI syntax extension 402 is used to encode and decode the video bitstream 110 of FIG. 1 for SVC.

The SVC VUI syntax extension 402 can include the type indicator 406, such as a svc_mvc_flag element, for identifying the type of coding used for the video bitstream 110. For example, the type indicator 406 can represent the type of coding using 0 to indicate AVC and 1 to indicate SVC.

The SVC VUI syntax extension 402 can include the entry count 136 of FIG. 1, such as num_entries_minus1 element, for identifying the number of entries associated with each frame in the video content 108 of FIG. 1. The entry count 136 indicates the number of entries minus 1 to map the entry count 136 from 0 to the number of entries minus 1.

For example, the entry count 136 can represent the number of entries associated with a stereoscopic instance of the video content 108. The entry count 136 can have a value of 1 to indicate that two images are associated with each frame and a value of 0 to represent the video bitstream 110 with only a single image per frame.

The SVC VUI syntax extension 402 can include a temporal identifier 410, such as a temporal_id element, to indicate the maximum number of temporal layers in the video content 108. The SVC VUI syntax extension 402 can include a dependency identifier 412, such as a dependency_id element, to indicate the spatial dependency between images. The SVC VUI syntax extension 402 can include a quality identifier 414, such as a quality_id element, to indicate a quality level identifier.

The dependency_id element and the quality_id element can be concatenated together to indicate the maximum value of DQID, data quality identification, for each subset of coded video sequences in the SVC VUI syntax extension 402 for HEVC. The maximum value of DQID is calculated by adding the dependency_id element and the quality_id element.

It has been discovered that encoding and decoding the video bitstream 110 using the SVC VUI syntax extension 402 increases video display quality, scalability, and reliability. Identifying and linking multiple images using the temporal_id, dependency_id, and quality_id defines the relationship between images to increase the quality of video display.

It has been discovered that encoding and decoding the video content 108 using the SVC VUI syntax extension 402 can reduce the size of the video bitstream 110 and reduce the need for video buffering. Reducing the size of the video bitstream 110 increases functionality and increases the performance of display of the video stream 120 of FIG. 1.

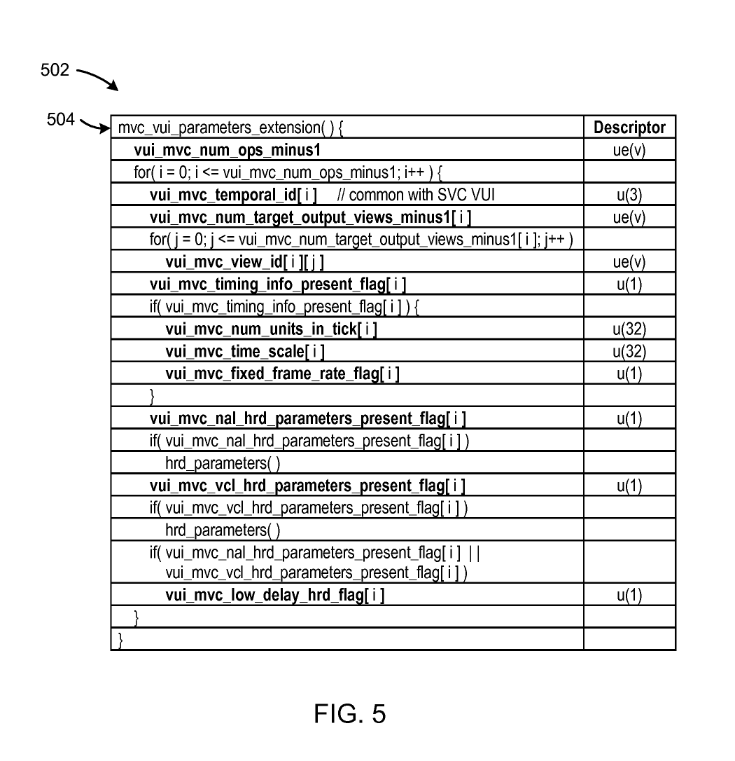

Referring now to FIG. 5, therein is shown an example of a Multiview Video Coding (MVC) VUI syntax 502. The MVC VUI syntax 502 includes descriptive information for encoding and decoding the video content 108 of FIG. 1 having multiview video information.

The MVC VUI syntax 502 includes elements as described in the MVC VUI syntax table of FIG. 5. The elements of the MVC VUI syntax 502 are arranged in a hierarchical structure as described in the MVC VUI syntax table of FIG. 5.

The MVC VUI syntax 502 includes a MVC VUI syntax header 504, such as a mvc_vui_parameters_extension element. The MVC VUI syntax header 504 is a descriptor for identifying the MVC VUI syntax 502 for HEVC. The MVC VUI syntax 502 is used to encode and decode the video bitstream 110 of FIG. 1 for MVC.

Multiview video coding is for enabling efficient encoding and decoding of multiple video sequences within a single compressed instance of the video bitstream 110. MVC can be used to encode stereoscopic video, as well as other types of three-dimensional (3D) video.

The MVC VUI syntax 502 can include the operation count 144 of FIG. 1, such as a vui_mvc_num_ops_minus1 element to identify the total number of operations in the video bitstream 110. The vui_mvc_num_ops_minus1 specifies the number of operation points for information entries present for multiview video coding, such as timing information, NAL HRD parameters, VCL HRD parameters, a pic_struct_present_flag element, or a combination thereof. The MVC VUI syntax 502 can include the operation identifier 142 of FIG. 1, such as the counter [i].

It has been discovered that encoding and decoding the video content 108 using the MVC VUI syntax 502 can reduce the size of the video bitstream 110 and reduce the need for video buffering. Reducing the size of the video bitstream 110 increases functionality and increases the performance of display of the video stream 112 of FIG. 1.

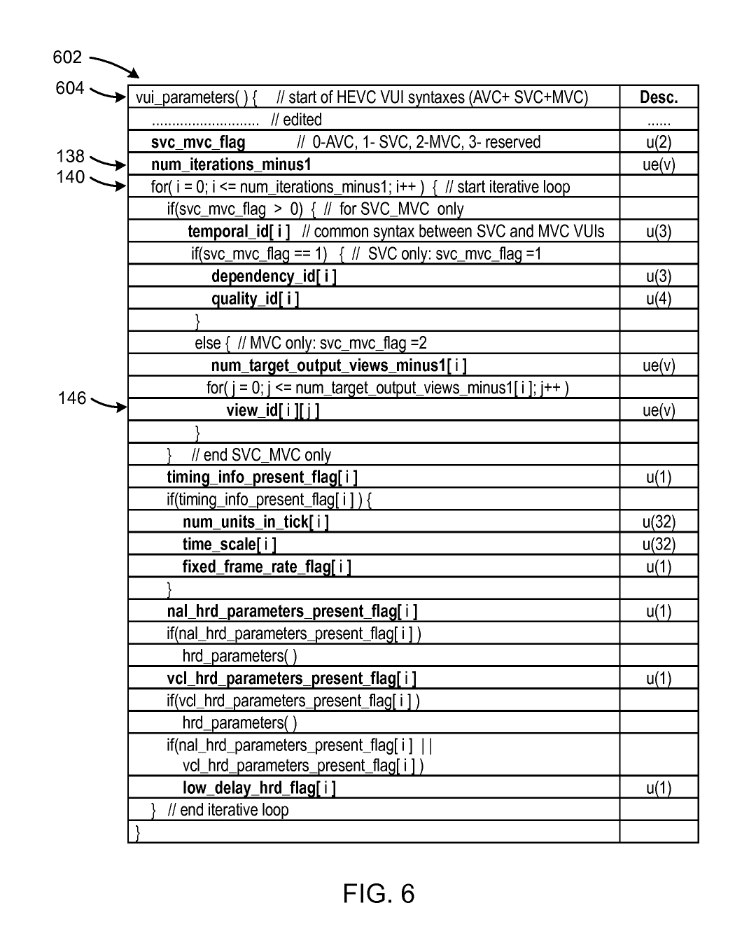

Referring now to FIG. 6, therein is shown an example of a MVC VUI syntax extension 602. The MVC VUI syntax extension 602 is a combination of Advanced Video Coding, Scalable Video Coding, and Multiview Video Coding elements.

The MVC VUI syntax extension 602 includes elements as described in the MVC VUI syntax extension table of FIG. 6. The elements of the MVC VUI syntax extension 602 are arranged in a hierarchical structure as described in the MVC VUI syntax extension table of FIG. 6.

The MVC VUI syntax extension 602 includes a MVC extension header 604, such as a vui_parameters element. The MVC VUI syntax extension 602 is a descriptor for identifying the MVC VUI syntax extension 602 for HEVC. The MVC VUI syntax extension 602 is used to encode and decode the video bitstream 110 of FIG. 1 for AVC, SVC, and MVC video.

The MVC VUI syntax extension 602 can include the type indicator 406 of FIG. 4, such as a svc_mvc_flag element, for identifying the type of coding used for the video bitstream 110. For example, the type indicator 406 can represent the type of coding using a value of 0 to indicate AVC, 1 to indicate SVC, and 2 to indicate MVC.

The MVC VUI syntax extension 602 can include the iteration identifier 138 for differentiating between multiple coded video sequences. The MVC VUI syntax extension 602 can include the iteration count 140, such as num_iterations_minus1 element, for identifying the number of iterations associated with each frame in the video content 108 of FIG. 1. Each iteration can represent one of multiple scalable video layer extensions. The iteration count 140 indicates the number of iterations minus 1 to map the range of iterations from 0 to the number of iterations minus 1.

For SVC video, the num_iterations_minus1 element indicates multiple iterations for multiple scalable video layer extensions. For MVC video, the num_iterations_minus1 element indicates multiple operation points for multi-view video.

The MVC VUI syntax extension 602 can include the view identifier 146, such as a view_id element. The view identifier 146 is a value identifying a view within a multiview configuration for displaying the video content 108.

It has been discovered that encoding and decoding the video bitstream 110 using the MVC VUI syntax extension 602 increases video display quality, scalability, and reliability. Identifying and linking multiple images from multiple views using the temporal_id, dependency_id, and quality_id defines the relationship between images to increase the quality of video display.

It has been discovered that encoding and decoding the video content 108 using the MVC VUI syntax extension 602 can reduce the size of the video bitstream 110 and reduce the need for video buffering. Reducing the size of the video bitstream 110 increases functionality and increases the performance of display of the video stream 112 of FIG. 1.

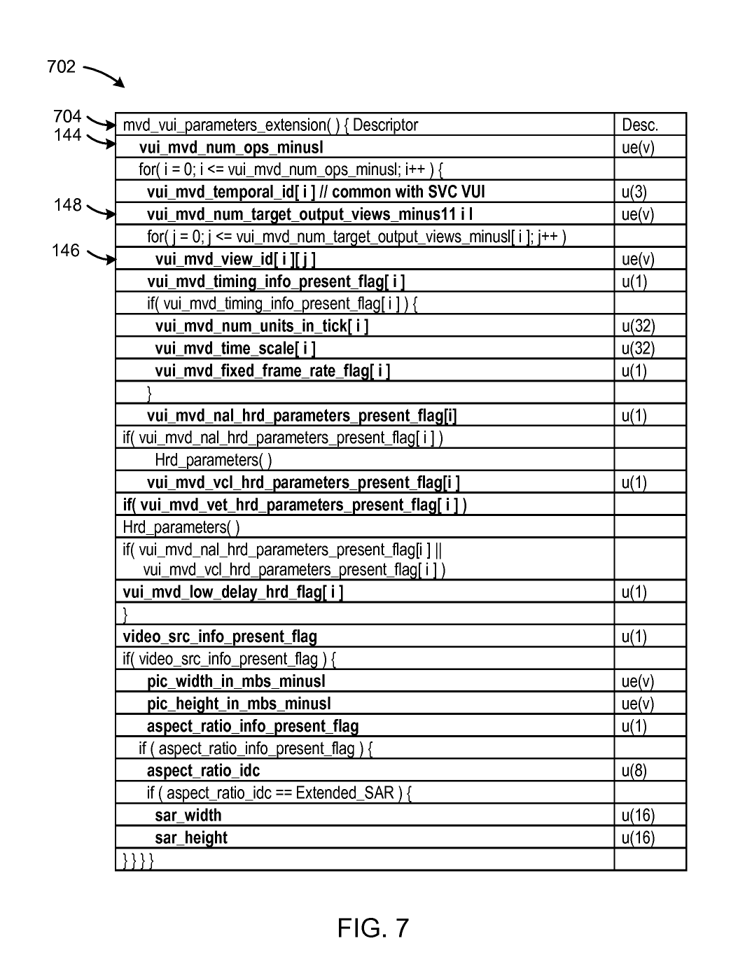

Referring now to FIG. 7, therein is shown an example of a Multiview Video plus Depth (MVD) VUI syntax 702. The MVD VUI syntax 702 includes descriptive information for encoding and decoding the video content 108 of FIG. 1 having three-dimensional video (3DV) information and scalable video coding information.

The MVD VUI syntax 702 includes elements as described in the MVD VUI syntax table of FIG. 7. The elements of the MVD VUI syntax 702 are arranged in a hierarchical structure as described in the MVD VUI syntax extension table of FIG. 7.

The MVD VUI syntax 702 includes a MVD header 704, such as a mvd_vui_parameters_extension element. The MVD header 704 is a descriptor for identifying the MVD VUI syntax 702 for HEVC. The MVD VUI syntax 702 is used to encode and decode the video bitstream 110 of FIG. 1.

The MVD VUI syntax 702 can include the operation count 144 of FIG. 1, such as a vui_mvd_num_ops_minus1 element to identify the total number of operations in the video bitstream 110. The MVD VUI syntax 702 can include the operation identifier 142 of FIG. 1, such as the counter [i].

The MVD VUI syntax 702 can include the view count 148, such as a vui_mvd_num_target_output_views_minus1 element to identify views in a multiview configuration. The MVD VUI syntax 702 can include the view identifier 146, such as a vui_mvd_view_id element.

It has been discovered that the MVD VUI syntax 702 provides increased functionality and improved performance by enabling displaying the video stream 112 of FIG. 1 in a multiview configuration having more than one view displayed simultaneously. By identifying the view identifier 146 for a view in a multiview configuration of the view count 148 views, the MVD VUI syntax 702 enables multiview functionality with reduced overhead.

It has been discovered that encoding and decoding the video content 108 using the MVD VUI syntax 702 can reduce the size of the video bitstream 110 and reduce the need for video buffering. Reducing the size of the video bitstream 110 increases functionality and increases the performance of display of the video stream 112 of FIG. 1.

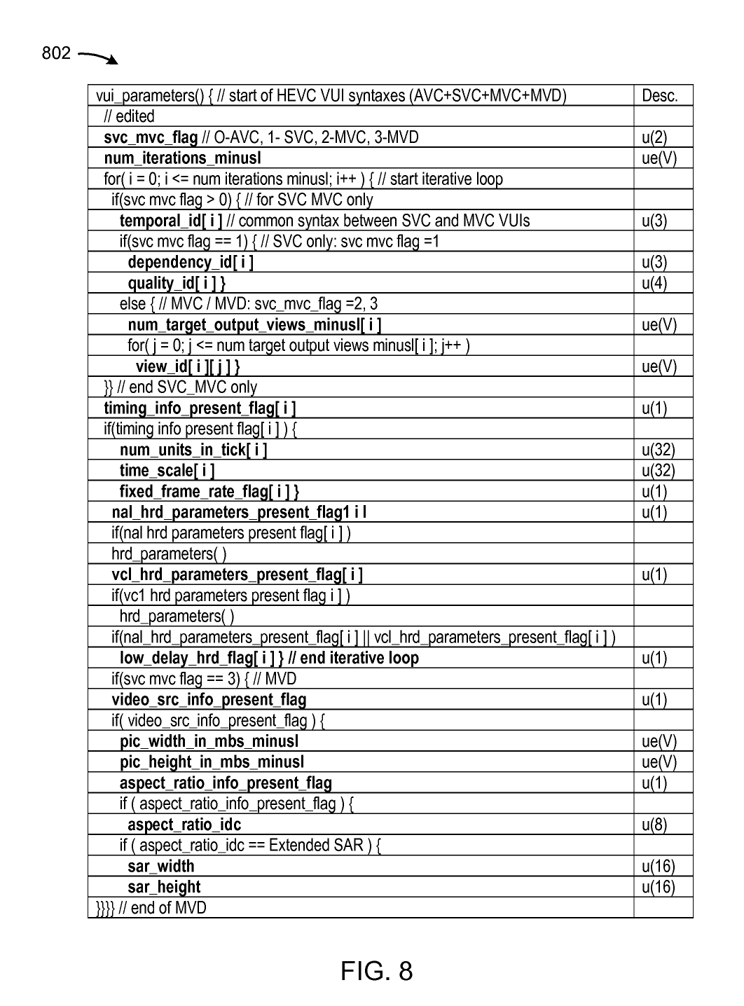

Referring now to FIG. 8, therein is shown an example of a MVD VUI syntax extension 802. The MVD VUI syntax extension 802 is a combination of Advanced Video Coding, Scalable Video Coding, Multiview Video Coding, and Multiview Video plus Depth elements.

The MVD VUI syntax extension 802 includes elements as described in the MVD VUI syntax extension table of FIG. 8. The elements of the MVD VUI syntax extension 802 are arranged in a hierarchical structure as described in the MVD VUI syntax extension table of FIG. 8.

The MVD VUI syntax extension 802 includes a MVD extension header 804, such as a vui_parameters element. The MVD extension header 804 is a descriptor for identifying the MVD VUI syntax extension 802 for HEVC. The MVD VUI syntax extension 802 is used to encode and decode the video bitstream 110 of FIG. 1 for AVC, SVC, MVC, and MVD video.

The MVD VUI syntax extension 802 can include the type indicator 406 of FIG. 4, such as a svc_mvc_flag, element, for identifying the type of coding used for the video bitstream 110. For example, the type indicator 406 can represent the type of coding using a value of 0 to indicate AVC, 1 to indicate SVC, 2 to indicate MVC, and 3 to indicate MVD.

The MVD VUI syntax extension 802 can include the iteration identifier 138 of FIG. 1. The MVD VUI syntax extension 802 can include the iteration count 140 of FIG. 1, such as num_iterations_minus1 element, for identifying the number of iterations associated with the video bitstream 110. The num_iterations_minus1 element can be a replacement for other elements in other coding syntaxes, such as the vui_ext_num_entries_minus1 for SVC, the vui_mvc_num_ops_minus1 for MVC, and the vui_mvd_num_ops_minus1 for MVD.

The iteration count 140 can encode the number of iterations minus 1 to map the range of iterations from 0 to the number of iterations minus 1. For example, for MVD video, the iteration count 140 indicates multiple operation points for multi-view and depth video.

The MVD VUI syntax extension 802 can include the view count 148 of FIG. 1, such as a num_target_output_views_minus1 element, to identify views per iteration in the multiview configuration. The MVD VUI syntax extension 802 can include the view identifier 146 of FIG. 1, such as a view_id element, for identifying each view in the multiview video information.

It has been discovered that encoding and decoding the video bitstream 110 using the MVD VUI syntax extension 802 increases video display quality, scalability, and reliability. Identifying and linking multiple images from multiple views using the temporal_id, dependency_id, and quality_id defines the relationship between images to increase the quality of video display.

It has been discovered that encoding and decoding the video content 108 of FIG. 1 using the MVC VUI syntax extension 602 of FIG. 6 can reduce the size of the video bitstream 110 and reduce the need for video buffering. Reducing the size of the video bitstream 110 increases functionality and increases the performance of display of the video stream 112 of FIG. 1.

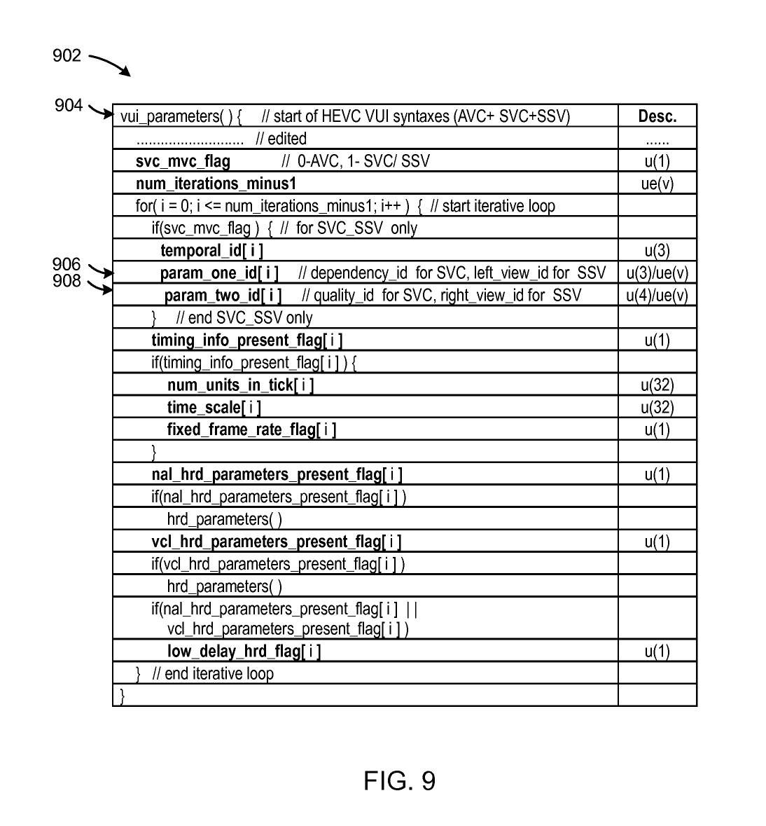

Referring now to FIG. 9, therein is shown an example of a Stereoscopic Video (SSV) VUI syntax extension 902. The SSV VUI syntax extension 902 is a combination of Advanced Video Coding, Scalable Video Coding, Multiview Video Coding, and Stereoscopic Video elements. The SSV VUI syntax extension 902 can be used to encode and decode left and right stereoscopic view video.

The SSV VUI syntax extension 902 includes elements as described in the SSV VUI syntax extension table of FIG. 9. The elements of the SSV VUI syntax extension 902 are arranged in a hierarchical structure as described in the SSV VUI syntax extension table of FIG. 9.

The SSV VUI syntax extension 902 includes a SSV extension header 904, such as a vui_parameters element. The SSV extension header 904 is a descriptor for identifying the SSV VUI syntax extension 902 for HEVC. The SSV VUI syntax extension 902 is used to encode and decode the video bitstream 110 of FIG. 1 for SSV video.

The SSV VUI syntax extension 902 can include the type indicator 406 of FIG. 4, such as a svc_mvc_flag element, for identifying the type of coding used for the video bitstream 110. For example, the type indicator 406 can represent the type of coding using a value of 0 to indicate AVC and a value of 1 to indicate SSV.

The SSV VUI syntax extension 902 can include a first context indicator 906, such as a param_one_id element, and a second context indicator 908, such as a param_two_id element. The terms first and second are used to differentiate between context indicators and do not imply any ordering, ranking, importance, or other property.

The first context indicator 906 can include different information depending on the type of video coding being performed. For example, the param_one_id element can represent a dependency_id element for SVC and a left_view_id for SSV.

The second context indicator 908 can include different types of information depending on the type of video coding being performed. For example, the param_two_id element can represent a quality_id element for SVC and a right_view_id for SSV.

It has been discovered that encoding and decoding the video bitstream 110 using the SSV VUI syntax extension 902 increases video display quality, scalability, and reliability for stereoscopic video. Identifying scalability factors for stereoscopic video using the first context indicator 906 and the second context indicator 908 increases the quality of the video bitstream 110.

It has been discovered that encoding and decoding the video content 108 of FIG. 1 using the SSV VUI syntax extension 902 can reduce the size of the video bitstream 110 and reduce the need for video buffering. Reducing the size of the video bitstream 110 increases functionality and increases the performance of display of the video stream 112 of FIG. 1.

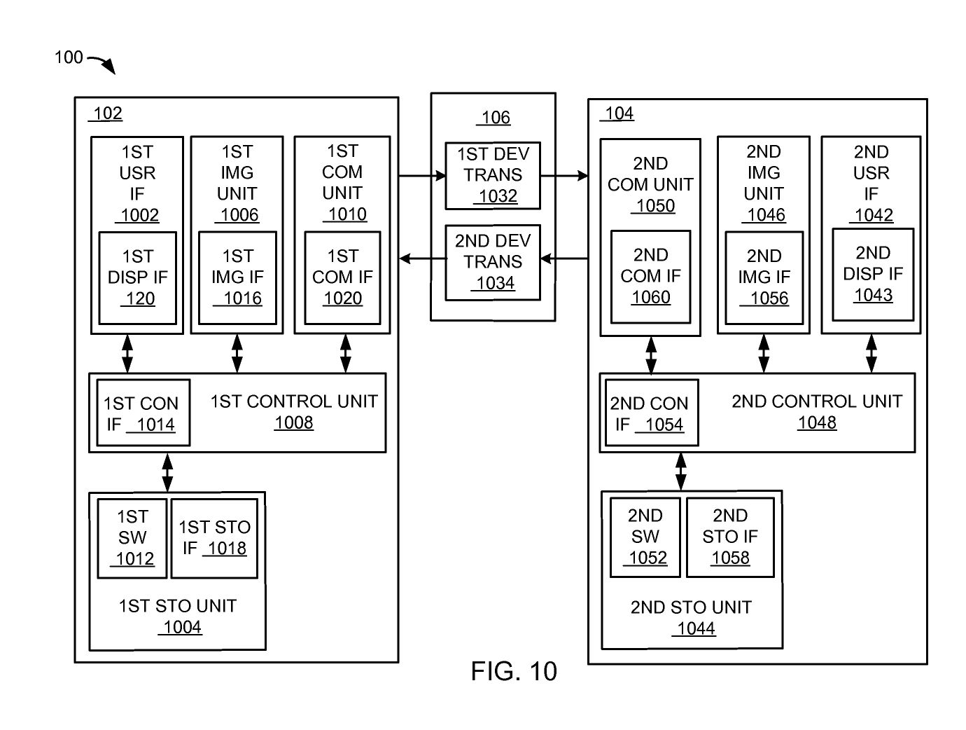

Referring now to FIG. 10, therein is shown a functional block diagram of the video coding system 100. The video coding system 100 can include the first device 102, the second device 104 and the communication path 106.

The first device 102 can communicate with the second device 104 over the communication path 106. The first device 102 can send information in a first device transmission 1032 over the communication path 106 to the second device 104. The second device 104 can send information in a second device transmission 1034 over the communication path 106 to the first device 102.

For illustrative purposes, the video coding system 100 is shown with the first device 102 as a client device, although it is understood that the video coding system 100 can have the first device 102 as a different type of device. For example, the first device can be a server. In a further example, the first device 102 can be the video encoder 102, the video decoder 104, or a combination thereof.

Also for illustrative purposes, the video coding system 100 is shown with the second device 104 as a server, although it is understood that the video coding system 100 can have the second device 104 as a different type of device. For example, the second device 104 can be a client device. In a further example, the second device 104 can be the video encoder 102, the video decoder 104, or a combination thereof.

For brevity of description in this embodiment of the present invention, the first device 102 will be described as a client device, such as a video camera, smart phone, or a combination thereof. The present invention is not limited to this selection for the type of devices. The selection is an example of the present invention.

The first device 102 can include a first control unit 1008. The first control unit 1008 can include a first control interface 1014. The first control unit 1008 can execute a first software 1012 to provide the intelligence of the video coding system 100.

The first control unit 1008 can be implemented in a number of different manners. For example, the first control unit 1008 can be a processor, an embedded processor, a microprocessor, a hardware control logic, a hardware finite state machine (FSM), a digital signal processor (DSP), or a combination thereof.

The first control interface 1014 can be used for communication between the first control unit 1008 and other functional units in the first device 102. The first control interface 1014 can also be used for communication that is external to the first device 102.

The first control interface 1014 can receive information from the other functional units or from external sources, or can transmit information to the other functional units or to external destinations. The external sources and the external destinations refer to sources and destinations external to the first device 102.

The first control interface 1014 can be implemented in different ways and can include different implementations depending on which functional units or external units are being interfaced with the first control interface 1014. For example, the first control interface 1014 can be implemented with electrical circuitry, microelectromechanical systems (MEMS), optical circuitry, wireless circuitry, wireline circuitry, or a combination thereof.

The first device 102 can include a first storage unit 1004. The first storage unit 1004 can store the first software 1012. The first storage unit 1004 can also store the relevant information, such as images, syntax information, video, maps, profiles, display preferences, sensor data, or any combination thereof.

The first storage unit 1004 can be a volatile memory, a nonvolatile memory, an internal memory, an external memory, or a combination thereof. For example, the first storage unit 1004 can be a nonvolatile storage such as non-volatile random access memory (NVRAM), Flash memory, disk storage, or a volatile storage such as static random access memory (SRAM).

The first storage unit 1004 can include a first storage interface 1018. The first storage interface 1018 can be used for communication between the first storage unit 1004 and other functional units in the first device 102. The first storage interface 1018 can also be used for communication that is external to the first device 102.

The first device 102 can include a first imaging unit 1006. The first imaging unit 1006 can capture the video content 108 from the real world. The first imaging unit 1006 can include a digital camera, an video camera, an optical sensor, or any combination thereof.

The first imaging unit 1006 can include a first imaging interface 1016. The first imaging interface 1016 can be used for communication between the first imaging unit 1006 and other functional units in the first device 102.

The first imaging interface 1016 can receive information from the other functional units or from external sources, or can transmit information to the other functional units or to external destinations. The external sources and the external destinations refer to sources and destinations external to the first device 102.

The first imaging interface 1016 can include different implementations depending on which functional units or external units are being interfaced with the first imaging unit 1006. The first imaging interface 1016 can be implemented with technologies and techniques similar to the implementation of the first control interface 1014.

The first storage interface 1018 can receive information from the other functional units or from external sources, or can transmit information to the other functional units or to external destinations. The external sources and the external destinations refer to sources and destinations external to the first device 102.

The first storage interface 1018 can include different implementations depending on which functional units or external units are being interfaced with the first storage unit 1004. The first storage interface 1018 can be implemented with technologies and techniques similar to the implementation of the first control interface 1014.

The first device 102 can include a first communication unit 1010. The first communication unit 1010 can be for enabling external communication to and from the first device 102. For example, the first communication unit 1010 can permit the first device 102 to communicate with the second device 104, an attachment, such as a peripheral device or a computer desktop, and the communication path 106.

The first communication unit 1010 can also function as a communication hub allowing the first device 102 to function as part of the communication path 106 and not limited to be an end point or terminal unit to the communication path 106. The first communication unit 1010 can include active and passive components, such as microelectronics or an antenna, for interaction with the communication path 106.

The first communication unit 1010 can include a first communication interface 1020. The first communication interface 1020 can be used for communication between the first communication unit 1010 and other functional units in the first device 102. The first communication interface 1020 can receive information from the other functional units or can transmit information to the other functional units.

The first communication interface 1020 can include different implementations depending on which functional units are being interfaced with the first communication unit 1010. The first communication interface 1020 can be implemented with technologies and techniques similar to the implementation of the first control interface 1014.

The first device 102 can include a first user interface 1002. The first user interface 1002 allows a user (not shown) to interface and interact with the first device 102. The first user interface 1002 can include a first user input (not shown). The first user input can include touch screen, gestures, motion detection, buttons, sliders, knobs, virtual buttons, voice recognition controls, or any combination thereof.

The first user interface 1002 can include the first display interface 120. The first display interface 120 can allow the user to interact with the first user interface 1002. The first display interface 120 can include a display, a video screen, a speaker, or any combination thereof.

The first control unit 1008 can operate with the first user interface 1002 to display video information generated by the video coding system 100 on the first display interface 120. The first control unit 1008 can also execute the first software 1012 for the other functions of the video coding system 100, including receiving video information from the first storage unit 1004 for display on the first display interface 120. The first control unit 1008 can further execute the first software 1012 for interaction with the communication path 106 via the first communication unit 1010.

For illustrative purposes, the first device 102 can be partitioned having the first user interface 1002, the first storage unit 1004, the first control unit 1008, and the first communication unit 1010, although it is understood that the first device 102 can have a different partition. For example, the first software 1012 can be partitioned differently such that some or all of its function can be in the first control unit 1008 and the first communication unit 1010. Also, the first device 102 can include other functional units not shown in FIG. 10 for clarity.

The video coding system 100 can include the second device 104. The second device 104 can be optimized for implementing the present invention in a multiple device embodiment with the first device 102. The second device 104 can provide the additional or higher performance processing power compared to the first device 102.

The second device 104 can include a second control unit 1048. The second control unit 1048 can include a second control interface 1054. The second control unit 1048 can execute a second software 1052 to provide the intelligence of the video coding system 100.

The second control unit 1048 can be implemented in a number of different manners. For example, the second control unit 1048 can be a processor, an embedded processor, a microprocessor, a hardware control logic, a hardware finite state machine (FSM), a digital signal processor (DSP), or a combination thereof.

The second control interface 1054 can be used for communication between the second control unit 1048 and other functional units in the second device 104. The second control interface 1054 can also be used for communication that is external to the second device 104.

The second control interface 1054 can receive information from the other functional units or from external sources, or can transmit information to the other functional units or to external destinations. The external sources and the external destinations refer to sources and destinations external to the second device 104.

The second control interface 1054 can be implemented in different ways and can include different implementations depending on which functional units or external units are being interfaced with the second control interface 1054. For example, the second control interface 1054 can be implemented with electrical circuitry, microelectromechanical systems (MEMS), optical circuitry, wireless circuitry, wireline circuitry, or a combination thereof.

The second device 104 can include a second storage unit 1044. The second storage unit 1044 can store the second software 1052. The second storage unit 1044 can also store the relevant information, such as images, syntax information, video, maps, profiles, display preferences, sensor data, or any combination thereof.

The second storage unit 1044 can be a volatile memory, a nonvolatile memory, an internal memory, an external memory, or a combination thereof. For example, the second storage unit 1044 can be a nonvolatile storage such as non-volatile random access memory (NVRAM), Flash memory, disk storage, or a volatile storage such as static random access memory (SRAM).

The second storage unit 1044 can include a second storage interface 1058. The second storage interface 1058 can be used for communication between the second storage unit 1044 and other functional units in the second device 104. The second storage interface 1058 can also be used for communication that is external to the second device 104.

The second storage interface 1058 can receive information from the other functional units or from external sources, or can transmit information to the other functional units or to external destinations. The external sources and the external destinations refer to sources and destinations external to the second device 104.

The second storage interface 1058 can include different implementations depending on which functional units or external units are being interfaced with the second storage unit 1044. The second storage interface 1058 can be implemented with technologies and techniques similar to the implementation of the second control interface 1054.

The second device 104 can include a second imaging unit 1046. The second imaging unit 1046 can capture the video content 108 of FIG. 1 from the real world. The first imaging unit 1006 can include a digital camera, an video camera, an optical sensor, or any combination thereof.

The second imaging unit 1046 can include a second imaging interface 1056. The second imaging interface 1056 can be used for communication between the second imaging unit 1046 and other functional units in the second device 104.

The second imaging interface 1056 can receive information from the other functional units or from external sources, or can transmit information to the other functional units or to external destinations. The external sources and the external destinations refer to sources and destinations external to the second device 104.

The second imaging interface 1056 can include different implementations depending on which functional units or external units are being interfaced with the second imaging unit 1046. The second imaging interface 1056 can be implemented with technologies and techniques similar to the implementation of the first control interface 1014.

The second device 104 can include a second communication unit 1050. The second communication unit 1050 can enable external communication to and from the second device 104. For example, the second communication unit 1050 can permit the second device 104 to communicate with the first device 102, an attachment, such as a peripheral device or a computer desktop, and the communication path 106.

The second communication unit 1050 can also function as a communication hub allowing the second device 104 to function as part of the communication path 106 and not limited to be an end point or terminal unit to the communication path 106. The second communication unit 1050 can include active and passive components, such as microelectronics or an antenna, for interaction with the communication path 106.

The second communication unit 1050 can include a second communication interface 1060. The second communication interface 1060 can be used for communication between the second communication unit 1050 and other functional units in the second device 104. The second communication interface 1060 can receive information from the other functional units or can transmit information to the other functional units.

The second communication interface 1060 can include different implementations depending on which functional units are being interfaced with the second communication unit 1050. The second communication interface 1060 can be implemented with technologies and techniques similar to the implementation of the second control interface 1054.

The second device 104 can include a second user interface 1042. The second user interface 1042 allows a user (not shown) to interface and interact with the second device 104. The second user interface 1042 can include a second user input (not shown). The second user input can include touch screen, gestures, motion detection, buttons, sliders, knobs, virtual buttons, voice recognition controls, or any combination thereof.

The second user interface 1042 can include a second display interface 1043. The second display interface 1043 can allow the user to interact with the second user interface 1042. The second display interface 1043 can include a display, a video screen, a speaker, or any combination thereof.

The second control unit 1048 can operate with the second user interface 1042 to display information generated by the video coding system 100 on the second display interface 1043. The second control unit 1048 can also execute the second software 1052 for the other functions of the video coding system 100, including receiving display information from the second storage unit 1044 for display on the second display interface 1043. The second control unit 1048 can further execute the second software 1052 for interaction with the communication path 106 via the second communication unit 1050.

For illustrative purposes, the second device 104 can be partitioned having the second user interface 1042, the second storage unit 1044, the second control unit 1048, and the second communication unit 1050, although it is understood that the second device 104 can have a different partition. For example, the second software 1052 can be partitioned differently such that some or all of its function can be in the second control unit 1048 and the second communication unit 1050. Also, the second device 104 can include other functional units not shown in FIG. 10 for clarity.

The first communication unit 1010 can couple with the communication path 106 to send information to the second device 104 in the first device transmission 1032. The second device 104 can receive information in the second communication unit 1050 from the first device transmission 1032 of the communication path 106.

The second communication unit 1050 can couple with the communication path 106 to send video information to the first device 102 in the second device transmission 1034. The first device 102 can receive video information in the first communication unit 1010 from the second device transmission 1034 of the communication path 106. The video coding system 100 can be executed by the first control unit 1008, the second control unit 1048, or a combination thereof.

The functional units in the first device 102 can work individually and independently of the other functional units. For illustrative purposes, the video coding system 100 is described by operation of the first device 102. It is understood that the first device 102 can operate any of the modules and functions of the video coding system 100. For example, the first device 102 can be described to operate the first control unit 1008.

The functional units in the second device 104 can work individually and independently of the other functional units. For illustrative purposes, the video coding system 100 can be described by operation of the second device 104. It is understood that the second device 104 can operate any of the modules and functions of the video coding system 100. For example, the second device 104 is described to operate the second control unit 1048.

For illustrative purposes, the video coding system 100 is described by operation of the first device 102 and the second device 104. It is understood that the first device 102 and the second device 104 can operate any of the modules and functions of the video coding system 100. For example, the first device 102 is described to operate the first control unit 1008, although it is understood that the second device 104 can also operate the first control unit 1008.

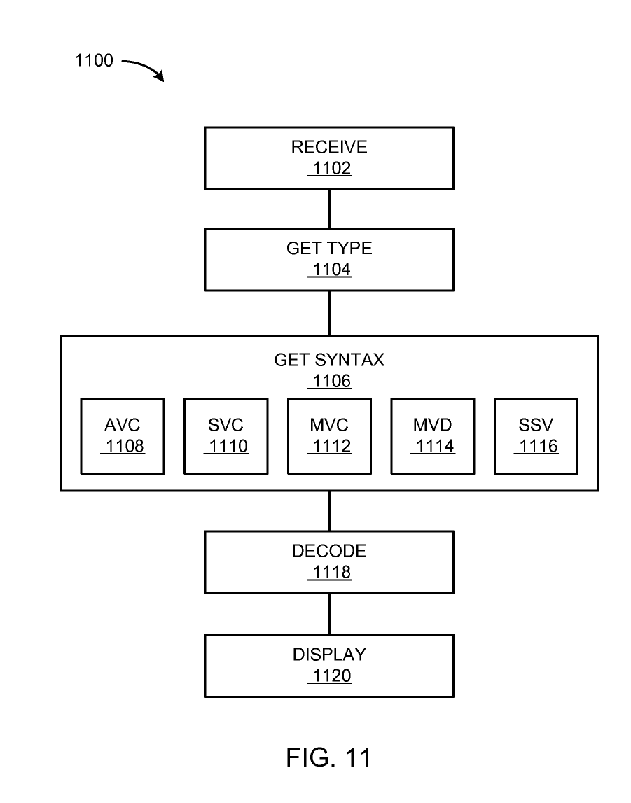

Referring now to FIG. 11, therein is shown a control flow 1100 of the video coding system 100 of FIG. 1. The control flow 1100 describes decoding the video bitstream 110 of FIG. 1 by receiving the video bitstream 110, extracting the video syntax 114 of FIG. 1, decoding the video bitstream 110, and displaying the video stream 112 of FIG. 1.

The video coding system 100 can include a receive module 1102. The receive module 1102 can receive the video bitstream 110 encoded by the video encoder 102 of FIG. 1.

The video bitstream 110 can be received in a variety of ways. For example, the video bitstream 110 can be received from the video encoder 102 of FIG. 1, as a pre-encoded video file (not shown), in a digital message (not shown) over the communication path 106 of FIG. 1, or a combination thereof.

The video coding system 100 can include a get type module 1104. The get type module 1104 can identify the type of video coding used to encode and decode the video bitstream 110 by extracting the syntax type 132 of FIG. 1.

The get type module 1104 can detect the syntax type 132 in a variety of ways. The get type module 1104 can determine the syntax type 132 by parsing the type indicator 406 of FIG. 4, such as the svc_mvc_flag element, from the video bitstream 110. In another example, the get type module 1104 can extract the syntax type 132 from the video syntax 114 extracting the type indicator 406 from the video bitstream 110 using a demultiplexer (not shown) to separate the video syntax 114 from the video image data of the video bitstream 110.

In an illustrative example, if the svc_mvc_flag has a value of 0, then the type indicator 406 is set to AVC. If the svc_mvc_flag has a value of 1, then the type indicator 406 is set to SVC. If the svc_mvc_flag element has a value of 2, then the type indicator 406 is set to MVC.

If the svc_mvc_flag element has a value of 3, then the type indicator 406 is set to MVD. If the svc_mvc_flag element has a value of 4, then the type indicator 406 is set to SSV. The syntax type 132 is assigned the value of the type indicator 406 extracted from the video bitstream 110.

The video coding system 100 can include a get syntax module 1106. The get syntax module 1106 can identify and extract the video syntax 114 embedded within the video bitstream 110.

For example, the video syntax 114 can be extracted by searching the video bitstream 110 for video usability information headers indicating the presence of the video syntax 114. In yet another example, the video syntax 114 can be extracted from the video bitstream 110 using a demultiplexer (not shown) to separate the video syntax 114 from the video image data of the video bitstream 110. In yet another example, the video syntax 114 can be extracted from the video bitstream 110 by extracting a sequence parameter set Raw Byte Sequence Payload (RBSP) syntax. The sequence parameter set RBSP is a syntax structure containing a integer number of bytes encapsulated in a network abstraction layer unit. The RBSP can be either empty or have the form of a string of data bits containing syntax elements followed by a RBSP stop bit and followed by zero or more addition bits equal to 0.

In another example, if the video bitstream 110 is received in a file, then the video syntax 114 can be detected by examining the file extension of the file containing the video bitstream 110. In yet another example, if the video bitstream 110 is received as a digital message over the communication path 106 of FIG. 1, then the video syntax 114 can be provided as a portion of the structure of the digital message.

The get syntax module 1106 can extract the individual elements of the video syntax 114 based on the syntax type 132. The get syntax module 1106 can include an AVC module 1108, a SVC module 1110, a MVC module 1112, a MVD module 1114, and a SSV module 1116 to extract the elements of the video syntax 114 based on the syntax type 132.

If the syntax type 132 indicates AVC coding, then the control flow can pass to the AVC module 1108. The AVC module 1108 can extract the AVC VUI syntax 202 of FIG. 2 from the video syntax 114. The elements of the AVC VUI syntax 202 can be extracted from the video syntax 114 according to the definition of the elements of the AVC VUI syntax 202 in the table of FIG. 2.

It has been discovered that using the AVC VUI syntax 202 increases reliability and reduces overhead by encoding and decoding the video content 108 of FIG. 1 according to the reduced data footprint of the video usability information of the AVC VUI syntax 202. Reducing the amount of data required to define the video bitstream 110 increases reliability and reduces data overhead.

If the syntax type 132 indicates SVC coding, then the control flow can pass to the SVC module 1110. The SVC module 1110 can extract the SVC VUI syntax extension 402 of FIG. 4 from the video syntax 114. The elements of the SVC VUI syntax extension 402 can be extracted from the video syntax 114 according to the definition of the elements of the SVC VUI syntax extension 402 in the table of FIG. 4.

It has been discovered that using the SVC VUI syntax extension 402 increases reliability and reduces overhead by encoding and decoding the video content 108 according to the reduced data footprint of the video usability information of the SVC VUI syntax extension 402. Reducing the amount of data required to define the video bitstream 110 increases reliability and reduces data overhead.

If the syntax type 132 indicates MVC coding, then the control flow can pass to the MVC module 1112. The MVC module 1112 can extract the MVC VUI syntax extension 602 of FIG. 6 from the video syntax 114. The elements of the MVC VUI syntax extension 602 can be extracted from the video syntax 114 according to the definition of the elements of the MVC VUI syntax extension 602 in the table of FIG. 6.

It has been discovered that using the MVC VUI syntax extension 602 increases reliability and reduces overhead by encoding and decoding the video content 108 according to the reduced data footprint of the video usability information of the MVC VUI syntax extension 602. Reducing the amount of data required to define the video bitstream 110 increases reliability and reduces data overhead for multiview video plus depth coding.

If the syntax type 132 indicates MVD coding, then the control flow can pass to the MVD module 1114. The MVD module 1114 can extract the MVD VUI syntax extension 802 of FIG. 8 from the video syntax 114. The elements of the MVD VUI syntax extension 802 can be extracted from the video syntax 114 according to the definition of the elements of the MVD VUI syntax 802 in the table of FIG. 8.

It has been discovered that using the MVD VUI syntax extension 802 increases reliability and reduces overhead by encoding and decoding the video content 108 according to the reduced data footprint of the video usability information of the MVD VUI syntax extension 802. Reducing the amount of data required to define the video bitstream 110 increases reliability and reduces data overhead for MVD coding.

If the syntax type 132 indicates SSV coding, then the control flow can pass to the SSV module 1116. The SSV module 1116 can extract the SSV VUI syntax extension 902 of FIG. 9 from the video syntax 114. The elements of the SSV VUI syntax extension 902 can be extracted from the video syntax 114 according to the definition of the elements of the SSV VUI syntax extension 902 in the table of FIG. 9.

It has been discovered that using the SSV VUI syntax extension 902 increases reliability and reduces overhead by encoding and decoding the video content 108 according to the reduced data footprint of the video usability information of the SSV VUI syntax extension 902. Reducing the amount of data required to define the video bitstream 110 increases reliability and reduces data overhead for stereoscopic video.

The video coding system 100 can include a decode module 1118. The decode module 1118 can decode the video bitstream 110 using the elements of the video syntax 114 for the extracted instance of the syntax type 132 to form the video stream 112.

The decode module 1118 can decode the video bitstream 110 using the syntax type 132 to determine the type of video coding used to form the video bitstream 110. If the syntax type 132 indicates advanced video coding, then the decode module 1118 can decode the video bitstream 110 using the AVC VUI syntax 202.

If the syntax type 132 indicates scalable video coding, then the decode module 1118 can decode the video bitstream 110 using the SVC VUI syntax extension 402. The SVC VUI syntax extension 402 can include an array of scalability elements having an array size as indicated by the entry count 136. For example, the SVC VUI syntax extension 402 can include an array of temporal_id[i], dependency_id[i], and quality_id[i] where [i] has a maximum value of the entry count 136.

If the syntax type 132 indicates multiview video coding, then the decode module 1118 can decode the video bitstream 110 using the MVC VUI syntax extension 602. If the syntax type 132 indicates MVC, then the MVC VUI syntax extension 602 can include an array of the view_id[i][j], where [i] has a maximum value of the entry count 136 and [j] has a maximum value of the view count 148 of FIG. 1.

If the syntax type 132 indicates multiview video coding plus depth, then the decode module 1118 can decode the video bitstream 110 using the MVD VUI syntax extension 802. If the syntax type 132 indicates multiview video coding plus depth, then the decode module 1118 can decode the video bitstream 110 using the MVD VUI syntax extension 802. If the syntax type 132 indicates MVD, then the MVD VUI syntax extension 802 can include an array of the view_id[i][j], where [i] has a maximum value of the entry count 136 and [j] has a maximum value of the view count 148.

If the syntax type 132 indicates SSV coding, then the decode module 1118 can decode the video bitstream 110 using the SSV VUI syntax extension 902. The SSV VUI syntax extension 902 can include an array of scalability elements having an array size as indicated by the entry count 136. For example, the SSV VUI syntax extension 902 can include an array of temporal_id[i], param_one_id[i], and param_two_id[i] where [i] has a maximum value of the entry count 136.

The video coding system 100 can include a display module 1120. The display module 1120 can receive the video stream 112 from the decode module 1118 and display on the display interface 120 of FIG. 1.

The physical transformation from the optical images of physical objects of the video content 108 to displaying the video stream 112 on the pixel elements of the display interface 120 of the video decoder 104 of FIG. 1 results in physical changes to the pixel elements of the display interface 120 in the physical world, such as the change of electrical state the pixel element, is based on the operation of the video coding system 100. As the changes in the physical world occurs, such as the motion of the objects captured in the video content 108, the movement itself creates additional information, such as the updates to the video content 108, that are converted back into changes in the pixel elements of the display interface 120 for continued operation of the video coding system 100.

The first software 1012 of FIG. 10 of the first device 102 can include the video coding system 100. For example, the first software 1012 can include the receive module 1102, the get type module 1104, the get syntax module 1106, the decode module 1118, and the display module 1120.

The first control unit 1008 of FIG. 10 can execute the first software 1012 for the receive module 1102 to receive the video bitstream 110. The first control unit 1008 can execute the first software 1012 for the get type module 1104 to determine the syntax type 132 for the video bitstream 110. The first control unit 1008 can execute the first software 1012 for the get syntax module 1106 to identify and extract the video syntax 114 from the video bitstream 110. The first control unit 1008 can execute the first software 1012 for the decode module 1118 to form the video stream 112. The first control unit 1008 can execute the first software 1012 for the display module 1120 to display the video stream 112.

The second software 1052 of FIG. 10 of the second device 104 can include the video coding system 100. For example, the second software 1052 can include the receive module 1102, the get type module 1104, the get syntax module 1106, and the decode module 1118.

The second control unit 1048 of FIG. 10 can execute the second software 1052 for the receive module 1102 to receive the video bitstream 110. The second control unit 1048 can execute the second software 1052 for the get type module 1104 to determine the syntax type 132 for the video bitstream 110. The second control unit 1048 can execute the second software 1052 for the get syntax module 1106 to identify and extract the video syntax 114 from the video bitstream 110. The second control unit 1048 can execute the second software 1052 for the decode module 1118 to form the video stream 112 of FIG. 1. The second control unit 1048 can execute the second software for the display module 1120 to display the video stream 112.

The video coding system 100 can be partitioned between the first software 1012 and the second software 1052. For example, the second software 1052 can include the get syntax module 1106, the decode module 1118, and the display module 1120. The second control unit 1048 can execute modules partitioned on the second software 1052 as previously described.

The first software 1012 can include the receive module 1102 and the get type module 1104. Depending on the size of the first storage unit 1004 of FIG. 10, the first software 1012 can include additional modules of the video coding system 100. The first control unit 1008 can execute the modules partitioned on the first software 1012 as previously described.

The first control unit 1008 can operate the first communication unit 1010 of FIG. 10 to send the video bitstream 110 to the second device 104. The first control unit 1008 can operate the first software 1012 to operate the first imaging unit 1006 of FIG. 10. The second communication unit 1050 of FIG. 10 can send the video stream 112 to the first device 102 over the communication path 106.

The video coding system 100 describes the module functions or order as an example. The modules can be partitioned differently. For example, the get type module 1104, the get syntax module 1106, and the decode module 1118 can be combined. Each of the modules can operate individually and independently of the other modules.

Furthermore, data generated in one module can be used by another module without being directly coupled to each other. For example, the get syntax module 1106 can receive the video bitstream 110 from the receive module 1102.

The modules can be implemented in a variety of ways. The receive module 1102, the get type module 1104, the get syntax module 1106, the decode module 1118, and the display module 1120 can be implemented in as hardware accelerators (not shown) within the first control unit 1008 or the second control unit 1048, or can be implemented in as hardware accelerators (not shown) in the first device 102 or the second device 104 outside of the first control unit 1008 or the second control unit 1048.

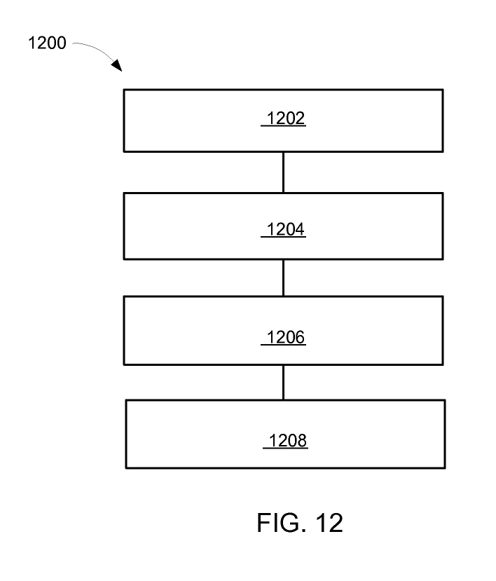

Referring now to FIG. 12, therein is shown a flow chart of a method 1200 of operation of the video coding system 100 of FIG. 1 in a further embodiment of the present invention. The method 1200 includes: receiving a video bitstream in a block 1202; identifying a syntax type of the video bitstream in a block 1204; extracting a video syntax from the video bitstream for the syntax type in a block 1206; and forming a video stream based on the video syntax for displaying on a device in a block 1208.

It has been discovered that the present invention thus has numerous aspects. The present invention valuably supports and services the historical trend of reducing costs, simplifying systems, and increasing performance. These and other valuable aspects of the present invention consequently further the state of the technology to at least the next level.

Thus, it has been discovered that the video coding system of the present invention furnishes important and heretofore unknown and unavailable solutions, capabilities, and functional aspects for efficiently coding and decoding video content for high definition applications. The resulting processes and configurations are straightforward, cost-effective, uncomplicated, highly versatile and effective, can be surprisingly and unobviously implemented by adapting known technologies, and are thus readily suited for efficiently and economically manufacturing video coding devices fully compatible with conventional manufacturing processes and technologies. The resulting processes and configurations are straightforward, cost-effective, uncomplicated, highly versatile, accurate, sensitive, and effective, and can be implemented by adapting known components for ready, efficient, and economical manufacturing, application, and utilization.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a video coding system comprising:
receiving a video bitstream;
identifying a syntax type of the video bitstream;
extracting a video syntax from the video bitstream for the syntax type; and
forming a video stream based on the video syntax for displaying on a device.

2. The method as claimed in claim 1 wherein extracting the video syntax includes identifying the syntax type for the video bitstream for a scalable video coding video usability information syntax extension.

3. The method as claimed in claim 1 wherein extracting the video syntax includes identifying the syntax type for the video bitstream for a multiview video coding video usability information syntax extension.

4. The method as claimed in claim 1 wherein extracting the video syntax includes identifying the syntax type for the video bitstream for an multiview video plus depth video usability information syntax extension.

5. The method as claimed in claim 1 wherein extracting the video syntax includes identifying the syntax type for the video bitstream for a stereoscopic video usability information syntax extension.

6. A method of operation a video coding system comprising:
receiving a video bitstream for a video content;
identifying a syntax type of the video content from the video bitstream;
extracting a video syntax from the video bitstream for the syntax type; and
forming a video stream by decoding the video bitstream using the video syntax for displaying on a device.

7. The method as claimed in claim 6 wherein forming the video stream includes forming the video stream for a resolution greater than or equal to 3840 by 2160.

8. The method as claimed in claim 6 wherein extracting the video syntax includes:
extracting a dependency identifier for a view identifier in a set of the iteration identifier of the video syntax; and
decompressing the video bitstream based on the dependency identifier.

9. The method as claimed in claim 6 wherein extracting the video syntax includes:
extracting a temporal identifier for each entry count of the video syntax; and
decompressing the video bitstream based on the temporal identifier.

10. The method as claimed in claim 6 wherein extracting the video syntax includes:
extracting a quality identifier for each entry count of the video syntax; and
decompressing the video bitstream based on the quality identifier.

11. A video coding system comprising:
a receive module for receiving a video bitstream;
a get type module, coupled to the receive module, for identifying a syntax type from the video bitstream;
a get syntax module, coupled to the get type module, for extracting a video syntax from the video bitstream for the syntax type; and
a decode module, coupled to the get syntax module, for forming a video stream based on the video syntax and the video bitstream for displaying on a device.

12. The system as claimed in claim 11 wherein the decode module is for identifying the syntax type for the video bitstream for a scalable video coding video usability information syntax extension.

13. The system as claimed in claim 11 wherein the decode module is for identifying the syntax type for the video bitstream for a multiview video coding video usability information syntax extension.

14. The system as claimed in claim 11 wherein the decode module is for identifying the syntax type for the video bitstream for a multiview video plus depth video usability information syntax extension.

15. The system as claimed in claim 11 wherein the decode module is for identifying the syntax type for the video bitstream for a stereoscopic video usability information syntax extension.

16. The system as claimed in claim 11 wherein:
the receive module is for receiving the video bitstream for a video content; and
the decode module is for forming the video stream by decoding the video bitstream.

17. The system as claimed in claim 16 wherein the decode module is for forming the video stream for a resolution greater than or equal to 3840 by 2160.

18. The system as claimed in claim 16 wherein the decode module is for extracting a dependency identifier for a view identifier in a set of the iteration identifier of the video syntax and decompressing the video bitstream based on the dependency identifier.

19. The system as claimed in claim 16 wherein the decode module is for extracting a temporal identifier for an entry count of the video syntax and decompressing the video bitstream based on the temporal identifier.

20. The system as claimed in claim 16 wherein the decode module is for extracting a quality identifier for an entry count of the video syntax and decompressing the video bitstream based on the quality identifier.
